(19) United States
(12) Patent Application Publication
(10) Pub. No.: US 2004/0219492 A1
(43) Pub. Date: Nov. 4, 2004

(54) Method, system and program product for designing an educational program and providing educational content

(75) Inventors: Janis A. Morariu, Hardy, VA (US); Catherine P. Rickelman, Marietta, GA (US); Janell Straach, Coppell, TX (US); Margaret A. Strong, Newnan, GA (US); Claudia L. Woody, Atlanta, GA (US); Elizabeth E. Wright, Dallas, TX (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/427,367

(22) Filed: May 1, 2003

(51) Int. Cl. G09B 19/00

(52) U.S. Cl. 434/118

(57) ABSTRACT

Under the present invention, a design repository having modules that each include a framework for developing educational content is provided. Also provided is a content repository that has modules that correspond to the modules of the design repository. An educational program is designed by selecting one or more modules of the design repository based on an assessment of a set of requirements. Using the framework in the selected modules educational content for the educational program can be developed. Moreover, by accessing the modules of the content repository that correspond to the selected modules of the design repository, previously created educational content can be retrieved. Once provided (e.g., developed or retrieved), the educational content will be delivered to one or more intended recipients according to the designed educational program.

### FIELD OF THE INVENTION

The present invention generally relates to a method, system and program product for assessing a set of requirements, designing an educational program and providing educational content. Specifically, the present invention allows an educational program to be designed by selecting one or more modules of a design repository based on a set of requirements, and educational content pertaining to the designed educational program to be assembled or retrieved from a content repository.

### BACKGROUND OF THE INVENTION

As technology in business continues to advance, education can be critical to the success of any organization. For example, as a business faces rapid changes and diversity in its competitive market and its technological base, it is important that personnel be sufficiently educated. Since many organizations have finite resources, education of personnel must often be based on a desired proficiency/competency level, a time frame and a cost factor.

In providing education within an organization, several types of delivery strategies are possible. One type of delivery strategy is commonly referred to as “informative,” and involves the communication of information to one or more “learners.” This type of delivery strategy is often practiced when a learner obtains content via the World Wide Web. Another type of delivery strategy is referred to as “interactive,” which involves interaction of a learner with one or more computer programs. Still another type of delivery strategy is referred to as “collaborative.” A collaborative delivery strategy typically involves remote interaction of a learner with peers, a mentor or an instructor (e.g., over a network). Collaborative delivery strategy is commonly practiced in a “distance learning” environment. Yet another type of delivery strategy is referred to as “co-located.” This type of delivery strategy involves in-person instruction or mentoring such as in a classroom environment.

In providing optimal education to individuals, an organization need not be limited to one type of delivery strategy. That is, the most efficient and cost effective manner of educating individuals could involve a combination of delivery strategies. This phenomena is typically referred to as “blended learning/education.” For example, assume an organization wishes to educate 25 individuals regarding certain health care regulations (e.g., Health Insurance Portability and Accountability Act or HIPPA). Further assume that the organization wishes the individuals to have an expert proficiency level in the regulations, and is not concerned about the cost. In this scenario, an educational program could involve both co-located and collaborative delivery strategies.

Unfortunately, although an organization might be well equipped to deliver an educational program to its personnel, the organization might not be well equipped to design the most effective program. Specifically, the organization might not be capable of assessing its educational requirements and then selecting the appropriate delivery strategies. Moreover, the organization might not be capable of developing the most effective educational content for the desired program.

In view of the foregoing, there exists a need for a method, system and program product for designing an educational program. A further need exists for a solution that provides educational content for an educational program. To this extent, a need exists for a design repository having a plurality of modules. Another need exists for an educational program to be designed by selecting one or more of the modules. Still yet, a need exists for the modules to each include a framework for developing educational content. A further need exists for any educational content developed to be stored within corresponding modules of a content repository.

### SUMMARY OF THE INVENTION

In general, the present invention provides a method, system and program product for assessing a set of requirements, designing an educational program and providing educational content. Specifically, under the present invention, a design repository having a plurality of modules is provided. The modules are organized within the design repository according to a set of (educational) delivery strategies and a set of proficiency levels. An educational program is designed by selecting one or more of the modules based on an assessment of a set of requirements (e.g., business purpose, desired results, environment parameters, desired proficiency level, cost constraints, time frame, etc.). Once the modules have been selected, educational content for the program will be provided (e.g., assembled in a hierarchical schema or retrieved from a content repository). A framework (e.g., patterns, templates, guidelines, tools, examples, etc.) within the selected modules can be used to develop and/or adapt the necessary educational content. In addition, previously developed educational content could be retrieved from modules within a content repository that correspond to the selected modules of the design repository.

According to a first aspect of the present invention, a method for designing an educational program is provided. The method comprises: providing a design repository having a plurality of modules, wherein each of the plurality of modules provides a framework for developing educational content; assessing a set of requirements for the educational program; and designing the educational program by selecting at least one of the plurality of modules based on the assessment of the educational requirements.

According to a second aspect of the present invention, a method for providing educational content is provided. The method comprises: assessing a set of requirements for an educational program; designing an educational program by selecting at least one of a plurality of modules of a design repository based on the assessment of the set of requirements; and providing educational content corresponding to the educational program.

According to a third aspect of the present invention, a system for designing an educational program is provided. The system comprises a requirement assessment system for assessing a set of requirements for the educational program, and for designing the educational program by selecting at least one of a plurality of modules of a design repository based on the assessment of the educational requirements, wherein each of the plurality of modules provides a framework for developing educational content.

According to a fourth aspect of the present invention, a program product stored on a recordable medium for designing an educational program is provided. When executed, the program product comprises program code for assessing a set of requirements for the educational program, and for designing the educational program by selecting at least one of a plurality of modules of a design repository based on the assessment of the educational requirements, wherein each of the plurality of modules provides a framework for developing educational content.

According to a fifth aspect of the present invention, a design repository for designing an educational program is provided. The design repository comprises a plurality of modules that each include a framework for developing educational content for the educational program, wherein the plurality of modules are organized in the design repository according to a set of educational delivery strategies and a set of proficiency levels.

Therefore, the present invention provides a method, system and program product for assessing requirements, designing an educational program, and providing educational content.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for designing an educational program and providing educational content according to the present invention.

FIG. 2A depicts an illustrative design repository according to the present invention.

FIG. 2B depicts an illustrative content repository according to the present invention.

FIG. 3 depicts the correspondence of the design repository of FIG. 2A to the content repository of FIG. 2B.

FIG. 4 depicts a more detailed view of the design repository of FIG. 2A.

FIG. 5 depicts an illustrative educational program assembled according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

For illustrative purposes, this description will have the following sections:

I. Technical Description

II. Illustrative Examples

I. Technical Description

As indicated above, the present invention provides a method, system and program product for assessing a set of requirements, designing an educational program and providing educational content. Specifically, under the present invention, a design repository having a plurality of modules is provided. The modules are organized within the design repository according to a set of (educational) delivery strategies and a set of proficiency levels. An educational program is designed by selecting one or more of the modules based on an assessment of a set of requirements (e.g., business purpose, desired results, environment parameters, desired proficiency level, cost constraints, time frame, etc.). Once the modules have been selected, educational content for the program will be provided (e.g., assembled in a hierarchical schema or retrieved from a content repository). A framework (e.g., patterns, templates, guidelines, tools, practice examples, etc.) within the selected modules can be used to develop and/or adapt the necessary educational content. In addition, previously developed educational content could be retrieved from modules within a content repository that correspond to the selected modules of the design repository.

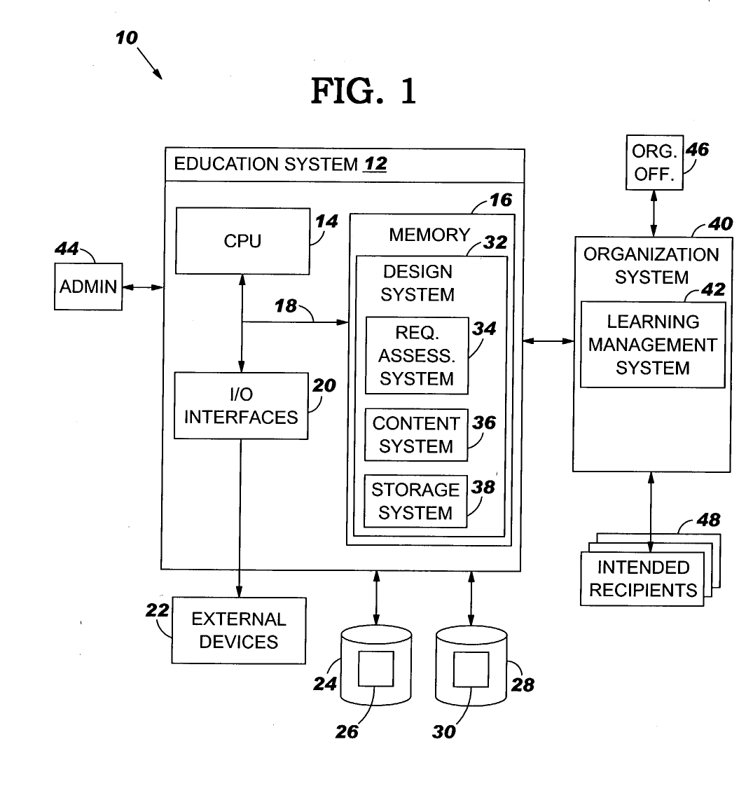

Referring now to FIG. 1, a system 10 for designing an educational program and for providing educational content is depicted. As shown, system 10 includes an education system 12 that communicates with an organization system 40. Education system 12 is intended to represent any computerized system that facilitates the designing of educational programs, and the providing of educational content. For example, education system 12 could be a server operated by a service provider or the like that helps other organizations implement educational programs for personnel. To this extent, organization system 40 is generally operated by or on behalf of an organization (e.g., business) that wishes to implement educational programs for intended recipients 48 (e.g., personnel). For example, organization system 40 could be operated by a hospital that wishes to educate/train its personnel on the latest health care legislation. It should be appreciated that the names “education system” and “organization” are used for illustrative purposes only, and that the teachings of the present invention are not intended to be limited thereby.

As shown, education system 12 generally includes central processing unit (CPU) 14, memory 16, bus 18, input/output (I/O) interfaces 20, external devices/resources 22 and storage units 24 and 28. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LED screen, hand-held device, keyboard, mouse, voice recognition system, speech output system, printer, monitor/display, facsimile, pager, etc. Bus 18 provides a communication link between each of the components in education system 12 and likewise may comprise any known type of transmission link, including electrical, optical, wireless, etc.

Storage units 24 and 28 can be any systems (e.g., databases) capable of providing storage for a design repository 26 and a content repository 30 under the present invention. As such, storage units 24 and 28 could each include one or more storage devices, such as a magnetic disk drive or an optical disk drive. In another embodiment, storage units 24 and 28 include data distributed across, for example, a local area network (LAN), wide area network (WAN) or a storage area network (SAN) (not shown).

It should be understood that separate storage units are shown for storing design repository 26 and content repository 30 for illustrative purposes only. To this extent, system 10 could be implemented with a single storage unit that provides storage for both design repository 26 and content repository 30. It should also be understood that although not shown, additional components, such as cache memory, communication systems, system software, etc., may be incorporated into education system 12. Moreover, although not shown, organization system 40 typically has computerized components (e.g., CPU, memory, etc.) similar to education system 12.

Communication between education system 12 and organization system 40 can occur in any known manner. For example, communication could occur via a direct hardwired connection (e.g., serial port), or via an addressable connection in a client-server (or server-server) environment that may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

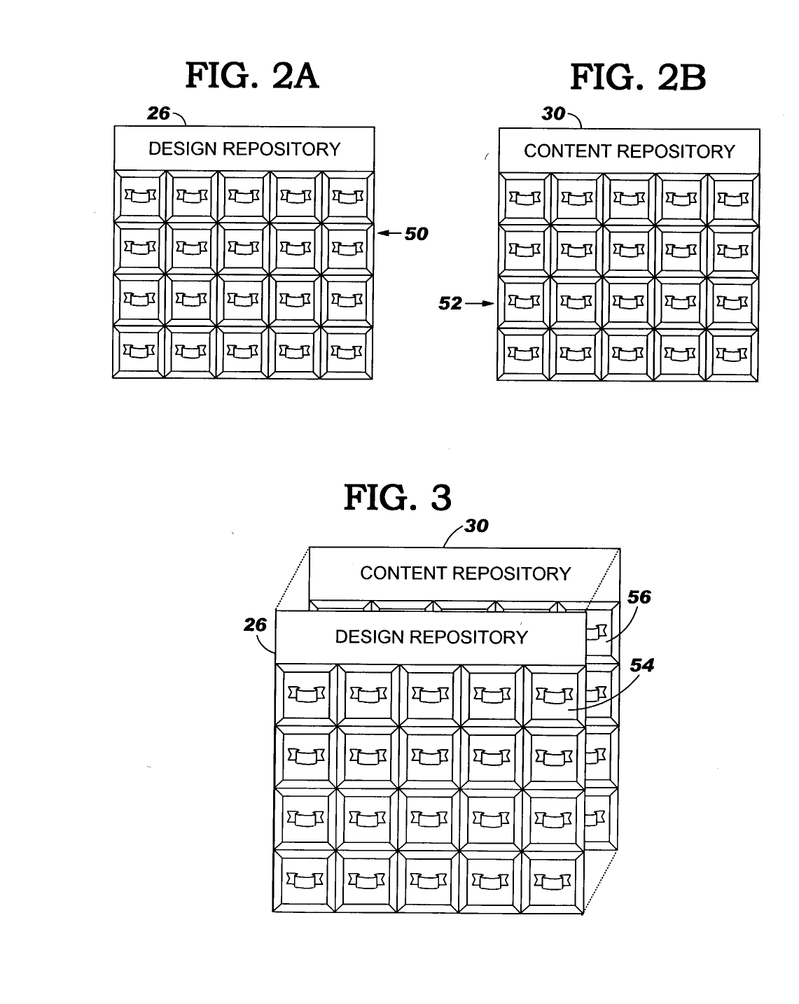

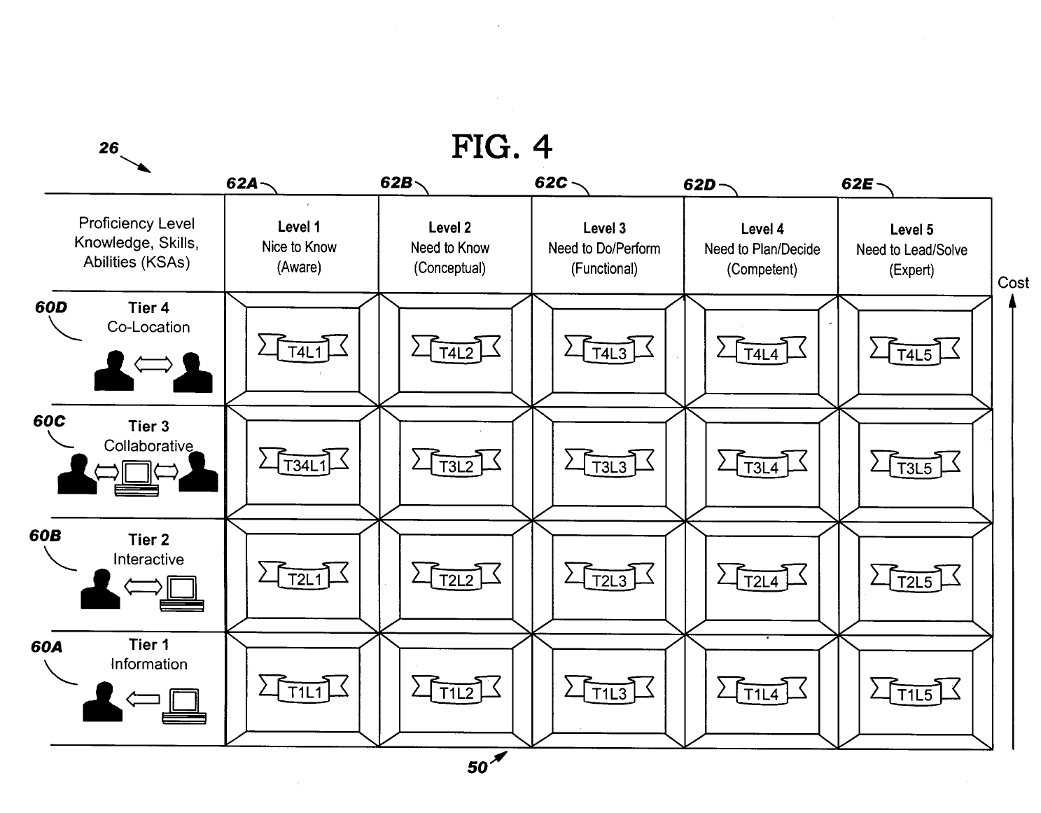

Stored in memory 16 of education system 12 is design system 32, which includes requirement assessment system 34, content system 36 and storage system 38. In general, design system 32 is used to design an educational program according to a set (e.g., one or more) of requirements provided from organization system 40 (e.g., from organization official 46), and provide educational content therefore. As will be further explained below, the educational program and content will be designed/provided based on design repository 26 and content repository 30. Referring to FIGS. 2A-B, design repository 26 and content repository 30 are shown in greater detail. As depicted, repositories 26 and 30 each include multiple modules 50 and 52, respectively, arranged into a column-row matrix as shown. As will be further described below in conjunction with FIG. 4, modules 50 and 52 are organized according to a set of delivery strategies and a set of proficiency levels.

In a typical embodiment, an educational program is first designed by selecting one or more modules of design repository 26 based on a set of requirements (e.g., as provided by organization official 46). Once the educational program is designed, content therefore can be provided. To this extent, modules 50 of design repository 26 each include a framework for developing educational content for an educational program. Specifically, each module 50 includes patterns, templates, best practice examples, tools, guidelines, etc. for developing educational content that will be used to educate intended recipients 48 about particular products and/or services. Moreover, the framework provided within modules 50 typically includes framework for both formal and informal uses, as well as high end and low end pricing for educating intended recipients 48 about any type of product or service.

As shown in FIG. 3, modules 52 of content repository 30 correspond to modules 50 of design repository (and vice versa). For example, module 54 corresponds to module 56. This correspondence is potentially valuable because modules 52 of content repository could each include “previously created” educational content that could be reused when appropriate. For example, assume that educational content was developed for educating personnel of company “A” about product “Z” using the framework in module 54. Further assume that in the following month, company “B” wished to educate its personnel about the same product. In this case, the educational content developed for company “A” could be retrieved from module 56 and reused, thus, obviating the need for company “B” to develop the educational content using the framework in module 54.

Referring now to FIG. 4, design repository 26 will be explained in greater detail. It should be understood in advance because content repository 30 and design repository 26 are “symmetrical,” both repositories are generally organized in the same manner. As shown, design repository 26 includes modules 50 organized according to a set of delivery strategies 60A-D and a set of proficiency levels 62A-E. Delivery strategy 60A is referred to as “tier 1” or the “informative” delivery strategy. As indicated above, delivery strategy 60A is where an intended recipient 48 will receive information/content such as over the World Wide Web. With delivery strategy 60A, no interaction typically takes place. Delivery strategy 60B is referred to as “tier 2” or the “interactive” delivery strategy. With delivery strategy 60B, one or more intended recipients 48 will interact with a computer program or the like. That is, no “human” to “human” interaction takes place. Delivery strategy 60C is referred to as “tier 3” or “collaborative.” In this delivery strategy, intended recipients 48 are educated by remotely interacting with peers, mentors and/or instructors. Such interaction is generally performed over a network such as the Internet or private network (e.g., in a distance learning scenario). Delivery strategy 60D is referred to as “tier 4” or “co-located.” This delivery strategy 60D involves person-person education in a common location. For example, the education of intended recipients 48 in a traditional class room environment would be considered co-located.

Set of proficiency levels 62A-E of design repository 26 represent a desired education level for intended recipients 48. As depicted, set of proficiency levels 62A-E are arranged as a progressive scale of proficiency. Proficiency level 62A or “level 1” represents a minimal or “awareness” level of proficiency, while proficiency level 62E or “level 5” represents a maximum or “expert” level of proficiency. Similarly, proficiency level 62B or “level 2” represents a “conceptual” level of proficiency, proficiency level 62C or “level3” represents a “functional” level of proficiency, while proficiency level 62D or “level 4” represents a “competent” level of proficiency.

In general, certain delivery strategies 60A-D are best suited for certain proficiency levels 62A-E. For example, the collaborate and co-located delivery strategies 60C-D are the most effective when educating an intended recipient to higher levels of proficiencies such as proficiency levels 62D-E. Similarly, the informative delivery strategy 60A could be sufficient for educating intended recipients 48 to lower levels of proficiencies such as proficiency levels 62A-B. In general, the delivery strategies 60A-D can get progressively more costly to implement. For example, educating a group of intended recipients using the co-located delivery strategy 60D will likely be more costly to deliver than educating a group of intended recipients 48 using the informative delivery strategy 60A. Accordingly, designing the most appropriate educational program often involves an assessment of an organization's requirements such as cost, desired proficiency level, time frame, etc. into account when designing an educational program.

It should be understood that the representation of design repository 26 and content repository 30 shown in FIGS. 2A-B, 3 and 4 is intended to be illustrative only and that many other variations could be implemented within the teachings of the present invention. For example repositories 26 and 30 could be implemented with a different quantity of delivery strategies 60A-D and/or proficiency levels 62A-E. Moreover, although shown as a two-dimensional structure, repositories 26 and 30 could be represented as any single or multidimensional structure.

Referring to FIGS. 1 and 4 collectively, the design of an educational program and providing of educational content therefore under the present invention will be described in greater detail. To first design an educational program, a set of requirements will be received by education system 12. Such requirements could be provided, for example, by organization official 46 and could include items such as a desired proficiency level of intended recipients 48, cost constraints (e.g., how much the organization is willing to spend on educating intended recipients 48), a time frame for completing the education of intended recipients 48, etc. Once the set of requirements have been provided, they will be assessed and an appropriate education program will be designed by selecting one or more appropriate modules 50 of design repository 26. The educational program designed need not be comprised of a single delivery strategy or proficiency level. That is, the present invention could design a blended educational program (learning solution) to best address the needs set forth in the requirements.

In one embodiment, the set of requirements are received and then manually assessed by administrator 44. In another embodiment, the set of requirements are received and are automatically assessed by requirement assessment system 34. In either event, based on the assessment, at least one of the modules 50 of design repository 26 will be selected. For example, assume that the set of requirements indicated a desire to educate five intended recipients 48 to an “expert” proficiency level for product “A” within two weeks. Further assume that cost was not a factor. In this case, administrator 44 or requirement assessment system 34 would select the modules 50 within design repository 26 that would best address the requirements. In this scenario, the modules selected would likely be one or more modules that pertain to delivery strategies 60B-D and proficiency levels 62D-E (e.g., one or more of modules T2L4, T3L4, T4L4, T2L5, T3L5 and T4L5 of FIG. 4).

As can be seen, the selection of the appropriate modules is a balance of the requirements set forth by organization official 46 and expertise on the part of administrator 44 or requirement assessment system 34. To this extent, requirement assessment system 34 is typically programmed with sufficient logic to select the delivery strategies and proficiency levels that best suit the requirements set forth. Once the educational program has been designed, content must be provided therefore. Under the present invention, there are at least two ways for “providing” educational content. In particular, educational content can be developed/assembled in a hierarchical schema using a framework in the selected modules, and/or previously developed content can be retrieved from modules of content repository 30 that correspond to the selected modules. In the case of the former, as indicated above, each module 50 in design repository 26 includes a framework (templates, patterns, best practice examples, tools, guidelines, etc.) for developing educational content. Assume in the above example that modules T3L4, T4L4 and T4L5 of FIG. 4 were selected. Organization official 46 would use the framework in these modules to develop the necessary educational content. To this extent, the framework provided in modules 50 typically allows educational content to be developed for any range of topics. For example, a module could contain a framework for educating intended recipients 48 about a particular product (e.g., a particular computer server), a service (e.g., sales training), etc.

In any event, the educational content developed could include anything that would be useful in educating intended recipients 48. For example, the educational content developed could include course manuals, instructor manuals, best practice examples, case studies, etc. In general, the educational material developed will include “information elements” that contain factual information about the product or service for which intended recipients 48 are being trained, “performance elements” that focus on learning activities related to the product or service, and “assessment elements” that provide a way to assess intended recipients' 48 learning of the subject matter (e.g., tests). In addition, the framework could also allow organization official 46 to develop “competency profiles” that intended recipients 48 will complete prior to commencing education. The competency profiles will determine the proficiency levels of intended recipients 48 prior to education. It could be the case that certain intended recipients 48 are more educated than others on the particular product or service. In this case, the educational program designed could be tailored to best meet the needs of each intended recipient. That is, the competency profiles could be used to prescribe an education program for each intended recipient 48.

In any event, educational content could also be provided by accessing the modules of content repository 30 that correspond to the selected modules of design repository 26. As indicated above, content repository 30 typically includes previously created educational content that may apply to a current educational program. Content system 36 (FIG. 1) will access the corresponding modules of content repository 30 and retrieve any appropriate educational content for organization official 46. Similarly, any content that is developed by organization official 46 using the framework in the modules of design repository 26 will be stored by storage system 38 in the corresponding modules of content repository 30 for future use.

As can be seen, educational content could be provided according to several different scenarios under the present invention:

A. No previously created educational content exists in the corresponding modules of the content repository 30 for a particular product/service. In this case, organization official 46 will develop all necessary educational content using the framework in the selected modules of design repository 26.

B. Previous educational content exists, but needs to be added to or supplemented. In this case, organization official 46 will use the educational content that is available in content repository 30, and develop new content using the framework in the selected modules.

C. Previous educational content exists, but it needs to be changed or revised to best fit the current situation. In this case, the framework in the selected modules of the design repository 26 would allow organizational official 46 to adapt the existing educational content into a more suitable form.

D. All content needed for the current educational program is provided in the corresponding modules of content repository 30. In this case, organization official 46 need not use the framework to create additional educational content.

Since content for an educational program could already exist within content repository 30, the content repository 30 should be checked first by content system 36 prior to the development of new content using the framework within the design repository 26.

Regardless of the scenario, once all necessary educational content for the designed educational program has been provided (e.g., developed and/or retrieved from content repository), intended recipients 48 can be educated according to the designed educational program. That is the organization, can deliver the educational program and content to intended recipients 48 in accordance with the delivery strategies of the selected modules. For the example illustrated above that resulted in modules T3L4, T4L4 and T4L5 being selected, the educational content corresponding thereto will be delivered as follows:

Educational content for module T3L4—collaborative delivery strategy 60C

Educational content for module T4L4—co-located delivery strategy 60D

Educational content for module T4L5—co-located delivery strategy 60D As further shown in FIG. 1, organization system 40 includes learning management system 42. This is intended to represent software, personnel, or any combination thereof that organizations typically have in place to facilitate the education of intended recipients 48.

In preparing for the delivery of the educational program and content via learning management system or scheduler 42, requirement assessment system 34 could output a proposed education program structure/schedule for the designed educational program. The proposed educational program structure will typically identify the module(s) selected, the delivery strategies, the subject matter for the educational content, etc. The proposed educational program structure would used by the organization to educate the intended recipients 48 via the organization's learning management system or scheduler 42.

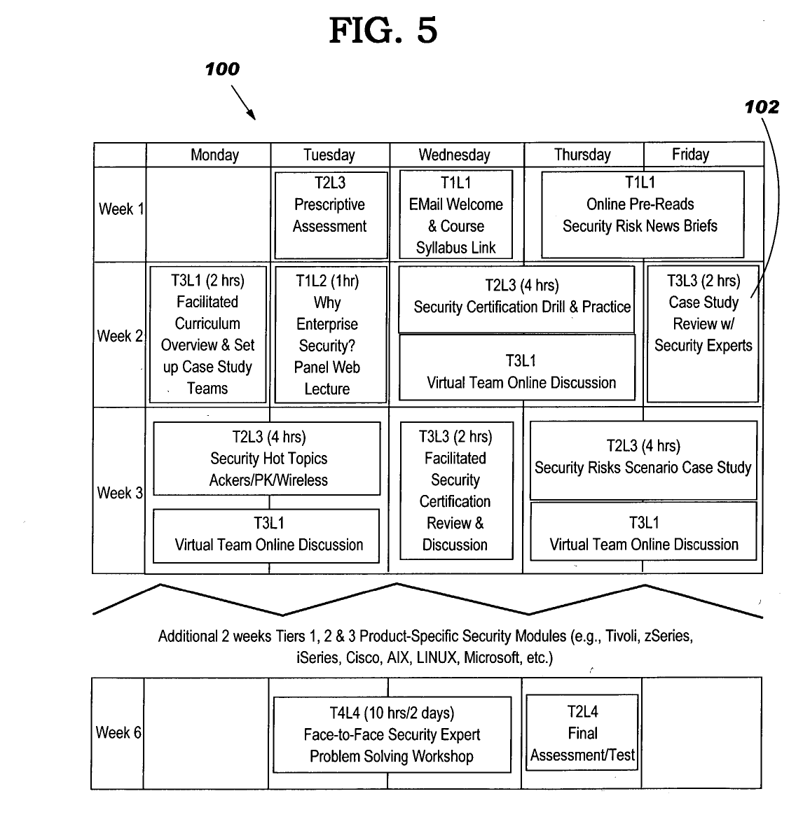

Referring to FIG. 5, an illustrative proposed educational program structure 100 is shown. As depicted, structure 100 resembles a Monday-Friday schedule for a six week period (e.g., a “boot camp”). Each day has one or more time blocks that specifically identify the corresponding module (i.e., delivery strategy and proficiency level) as well as topic of the educational content to be delivered. One or more intended recipients will be educated according to this schedule by receiving the corresponding educational content in the appropriate delivery strategies. For example, block 102 will result in “functional” level educational content pertaining to “case study review and security experts” being delivered using a “collaborative” delivery strategy.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

### II. ILLUSTRATIVE EXAMPLES

The above described teachings will now be further illustrated in the following examples:

### Example 1

Company “A” wishes to implement a policy that requires all new employees to be educated on using its web site. This week, new employee “Joe” commenced employment with company “A.” Assuming company “A” did not have an educational program in place for educating new employees on use of its web site, an educational program would have to be designed. Accordingly, company “A” would first provide its set of requirements for the program. As indicated above, this could include the proficiency level to which company “A” wishes Joe to be trained/educated. It could also include any cost constraints and time frame the education must meet. Further assume that the set of requirements provided by company “A” resulted in modules “X and Y” being selected. Content system 36 (FIG. 1) would retrieve any applicable educational content from the corresponding modules (X and Y) of content repository 30. Company “A” could also use the framework therein to develop any additional educational content or revise the educational content retrieved from content repository 30. In this case, the educational content developed by company “A” would be stored in the corresponding modules of content repository 30. In any event, prior to commencing education, Joe could complete a competency profile. This could reveal that Joe already meets company “A's” required proficiency level on use of the web site. Alternatively, it could reveal that Joe requires the complete education. Regardless of the outcome, the educational content will be delivered to Joe in accordance with the results of his competency profile.

### Example 2

Company “A” already has an educational program in place (e.g., it was designed when Joe commenced employment in Example 1). This week, “Jen” commences employment. In this case, the educational content has already been provided when educating Joe and can be reused and delivered in the same manner to Jen.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for designing an educational program, comprising:
providing a design repository having a plurality of modules, wherein each of the plurality of modules provides a framework for developing educational content;
assessing a set of requirements for the educational program; and
designing the educational program by selecting at least one of the plurality of modules based on the assessment of the educational requirements.

2. The method of claim 1, further comprising developing educational content for the educational program using the framework in the at least one of the plurality of modules.

3. The method of claim 2, further comprising storing the developed educational content in at least one of a plurality of modules of a content repository that correspond to the at least one of the plurality of modules in the design repository.

4. The method of claim 2, further comprising delivering the developed educational content to at least one intended recipient according to the educational program.

5. The method of claim 1, further comprising retrieving educational content from at least one of a plurality of modules of a content repository that correspond to the at least one of the plurality of modules of the design repository.

6. The method of claim 1, wherein the plurality of modules are organized in the design repository according to a set of delivery strategies and a set of proficiency levels.

7. The method of claim 6, wherein the set of delivery strategies comprises informative, interactive, collaborative and co-located.

8. The method of claim 6, wherein the set of proficiency levels comprises awareness, conceptual, functional, competent and expert.

9. The method of claim 1, wherein the framework within each of the plurality of modules comprises at least one of templates, patterns, tools and practice examples for developing the educational content.

10. A method for providing educational content, comprising:
assessing a set of requirements for an educational program;
designing an educational program by selecting at least one of a plurality of modules of a design repository based on the assessment of the set of requirements; and
providing educational content corresponding to the educational program.

11. The method of claim 10, wherein the providing step comprises developing the educational content using a framework provided in each of the at least one of the plurality of modules of the design repository.

12. The method of claim 11, wherein the framework within each of the plurality of modules comprises at least one of templates, patterns, tools and practice examples for developing the educational content.

13. The method of claim 10, wherein the providing step comprises retrieving the educational content from at least one of a plurality of modules of a content repository corresponding to the at least one of the plurality of modules of the design repository.

14. The method of claim 10, further comprising delivering the educational content to at least one intended recipient according to the educational program.

15. The method of claim 14, wherein the at least one intended recipient completes a competency profile prior to receiving the educational content.

16. The method of claim 10, wherein the plurality of modules are organized in the design repository according to a set of delivery strategies and a set of proficiency levels.

17. The method of claim 16, wherein the set of delivery strategies comprises informative, interactive, collaborative and co-located.

18. The method of claim 16, wherein the set of proficiency levels comprises awareness, conceptual, functional, competent and expert.

19. A system for designing an educational program, comprising a requirement assessment system for assessing a set of requirements for the educational program, and for designing the educational program by selecting at least one of a plurality of modules of a design repository based on the assessment of the educational requirements, wherein each of the plurality of modules provides a framework for developing educational content.

20. The system of claim 19, wherein educational content for the educational program is developed using the framework in the at least one of the plurality of modules.

21. The system of claim 20, further comprising a storage system for storing the developed educational content in at least one of a plurality of modules of a content repository that correspond to the at least one of the plurality of modules in the design repository.

22. The system of claim 19, further comprising a content system for retrieving educational content from at least one of a plurality of modules of a content repository that correspond to the at least one of the plurality of modules of the design repository.

23. The system of claim 19, wherein the plurality of modules are organized in the design repository according to a set of delivery strategies and a set of proficiency levels.

24. The system of claim 23, wherein the set of delivery strategies comprises informative, interactive, collaborative and co-located.

25. The system of claim 23, wherein the set of proficiency levels comprises awareness, conceptual, functional, competent and expert.

26. The system of claim 19, wherein the framework within each of the plurality of modules comprises at least one of templates, patterns, tools and practice examples for developing the educational content.

27. A program product stored on a recordable medium for designing an educational program, which when executed, comprises program code for assessing a set of requirements for the educational program, and for designing the educational program by selecting at least one of a plurality of modules of a design repository based on the assessment of the educational requirements, wherein each of the plurality of modules provides a framework for developing educational content.

28. The program product of claim 27, wherein educational content for the educational program is developed using the framework in the at least one of the plurality of modules.

29. The program product of claim 28, further comprising program code for storing the developed educational content in at least one of a plurality of modules of a content repository that correspond to the at least one of the plurality of modules in the design repository.

30. The program product of claim 27, further comprising program code for retrieving educational content from at least one of a plurality of modules of a content repository that correspond to the at least one of the plurality of modules of the design repository.

31. The program product of claim 28, wherein the plurality of modules are organized in the design repository according to a set of delivery strategies and a set of proficiency levels.

32. The program product of claim 31, wherein the set of delivery strategies comprises informative, interactive, collaborative and co-located.

33. The program product of claim 31, wherein the set of proficiency levels comprises awareness, conceptual, functional, competent and expert.

34. The program product of claim 27, wherein the framework within each of the plurality of modules comprises at least one of templates, patterns, tools and practice examples for developing the educational content.

35. A design repository for designing an educational program, comprising a plurality of modules that each include a framework for developing educational content for the educational program, wherein the plurality of modules are organized in the design repository according to a set of delivery strategies and a set of proficiency levels.

36. The design repository of claim 31, wherein the set of delivery strategies comprises informative, interactive, collaborative and co-located.

37. The design repository of claim 31, wherein the set of proficiency levels comprises awareness, conceptual, functional, competent and expert.

38. The design repository of claim 31, wherein the framework within each of the plurality of modules comprises at least one of templates, patterns, tools and practice examples for developing the educational content.

39. The design repository of claim 31, further comprising a content repository having a plurality of modules that correspond to the plurality of modules of the design repository, wherein at least one of the plurality of modules of the content repository provides the educational content.
